(19) United States
(12) Patent Application Publication
(10) Pub. No.: US 2013/0006996 A1
(43) Pub. Date: Jan. 3, 2013

(54) Clustering E-Mails Using Collaborative Information

(75) Inventor: Jayaprabhakar Kadarkarai, Hyderabad (IN)

(73) Assignee: Google Inc., Mountain View, CA (US)

(21) Appl. No.: 13/530,262

(22) Filed: Jun. 22, 2012

(30) Foreign Application Priority Data
Jun. 22, 2011 (IN) 2116/CHE/2011

(51) Int. Cl. G06F 17/30

(52) U.S. Cl. 707/738; 707/E17.046

(57) ABSTRACT

In an automatic electronic discovery search tool, emails subject to a litigation hold can be clustered using collaborative information rather than the contents to speed the review process. Collaborative information may include non-content fields such as the sender or recipient of a document or message. Documents may then be reviewed as a group based on the collaborative information, or further filtered in accordance with desired criteria.

### CROSS-REFERENCE TO RELATED APPLICATIONS

This application claims priority to Indian Provisional Application No. 2116/CHE/2011, filed Jun. 22, 2011, which is incorporated by reference herein in its entirety.

### BACKGROUND

Electronic discovery tools are used in the majority of modern court proceedings to capture and review documents that may be relevant to a particular proceeding. Conventional electronic discovery tools are used to duplicate various devices used in a company, extract potentially relevant information, and load the information into a database or other repository for review.

Managing and effectively analyzing the large number of documents typically reviewed in a litigation poses many problems to businesses and law firms. Grouping a set of relevant documents together may involve clustering algorithms, which typically compare documents together and group documents based on their similarity. Grouping documents on their contents may be a lengthy process in a large document set.

### SUMMARY

Embodiments relate to clustering documents relevant to a litigation. In one embodiment, a method of clustering a set of documents relevant to a litigation is disclosed. One or more non-content fields associated with each document in the set are identified. The set of documents is then clustered based on the data in the one or more non-content fields.

In an embodiment, the non-content field may include the a collaborator, such as the creator of the document, a recipient of the document, a sender of the document, a project identifier, a group recipient of the document, or an element of metadata.

In an embodiment, before the clustering operation takes place, non-content fields are assigned weights to control the outcome of the clustering operation.

In an embodiment, the set of documents to be clustered in distributed across a plurality of clients in a hosted user environment.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is an illustration of a term-document matrix.

FIG. 2 is an illustration of non-content portions of an electronic mail message.

FIG. 3A is a flow diagram of a method of clustering documents according to collaborative information in accordance with an embodiment.

FIG. 3B is a further flow diagram of a method of clustering documents in accordance with an embodiment.

FIG. 4 is a diagram of a document cluster system in accordance with an embodiment.

FIG. 5 is a diagram of an example computer system that can be used to implement embodiments of the present invention.

### DETAILED DESCRIPTION

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments, whether or not explicitly described.

Electronic discovery tools are used in the vast majority of modem litigations. Conventionally, a vendor will collect a set of electronic documents from a business facing a litigation or threat of litigation, and load the documents into a database for further analysis. Analysis may include sorting the documents, filtering them according to a query, or partitioning them to be reviewed by specific reviewers.

One useful analysis method is to group documents according to a certain theme or other criteria. Grouped documents can then be reviewed together, such that documents related to a particular criteria are all reviewed at the same time. This eliminates the need for a reviewer to keep track of multiple concepts at once. Instead, the reviewer can focus on one concept for a grouped set of documents, and move on to another later.

In a large business, the set of collected documents number from a thousand to millions of documents. These large sets of documents pose many issues. Database performance on large numbers of records degrades quickly. Analysis on even a relatively small set of documents may take hours or even days for a relatively simple analysis, such as a count of instances of a particular phrase.

Grouping a set of data, particularly documents, often involves clustering algorithms. Document clustering algorithms require a calculation of the similarity or dissimilarity between two or more documents or document clusters. A document cluster may be made up of two or more documents that exhibit similarity to each other.

Clustering text documents based on their full text may be a very time consuming operation. Although full text clustering may be used for small groups of documents, it is not scalable, as full text clustering quickly becomes impractical and prohibitively difficult for large numbers of documents.

In an embodiment, clustering on text may start by analyzing text documents to determine word counts. Documents may be then clustered together based on the word count statistics. For example, three documents that frequently mention the term “patent” may be clustered together, while four documents that frequently mention the word “copyright” may be clustered together, separate from the “patent” set.

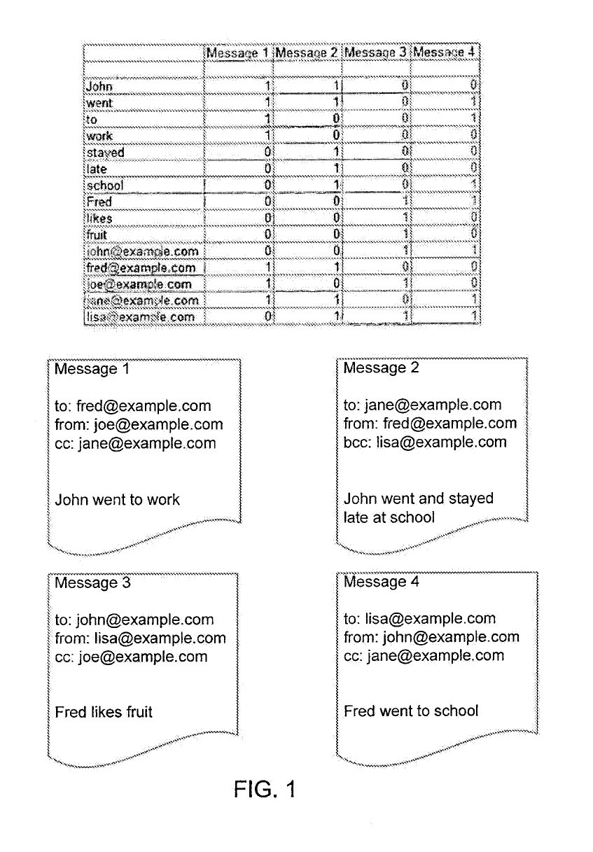

Clustering documents depends on the similarity between two documents. In many clustering algorithms, statistics regarding word frequency and presence in a document are used to compare documents. Documents may be represented as vectors of the words contained in each document. A term-document incidence matrix may be created to represent each document in a matrix. For example, a matrix may represent each document as a column, and each word contained in each document as a row. The matrix may omit common words such as “to” or “and”, since these words may be present in many documents. The intersection of each document column and each word row contains a value indicating whether the particular word is contained in the document. This value is entered for each document contained in the set to be clustered. A portion of a term-document index is shown in FIG. 1 for four exemplary electronic mail messages. The term-document index of FIG. 1 includes both content information of each electronic mail message, as well as non-content information, such as the recipient, sender, or other collaborators of each electronic mail message.

Once the term-document incidence matrix is created, each column is a vector representation of a particular document. In order to compare two documents and determine similarity between documents, a similarity calculation may be performed. Each document vector may be represented in a vector space model. To determine the similarity between two documents, a similarity measure, such as the cosine similarity, may be calculated. A cosine similarity function determines the cosine of the angle between two vectors, such as document vectors, and returns values between zero and 1. A value of zero indicates that the two documents are entirely dissimilar, while a value of 1 indicates that the two documents are identical.

In a large document set, such as in a set of documents determined to be relevant to a litigation, clustering operations may take many hours to complete. For example, creating a term-document incidence matrix for each document in a set of thousands of documents is a lengthy operation, since the matrix may contain a large number of rows and columns. Such a matrix also may take a large amount of space on a company's computing environment. Further calculating the similarity between the documents in the matrix, if the matrix contains many documents and/or words, is another lengthy operation. Thus, in a business computing environment, with many lengthy documents, clustering on full text may be an untenable solution, and is unscalable as a collection of documents grows.

Non-content portions of documents, however, generally contain less data. Non-content fields of a text document, for example, may include elements of metadata, such as the file name of the document, the owner or collaborator of the document, viewers of the document, or any other non-content field. Non-content fields of an electronic mail message may include collaborators, such as the sender or recipients of the e-mail, or other metadata fields of the message. Collaborators may include e-mail addresses found in the from, to, cc, bcc, reply-to, or other fields of an electronic mail message. In a given e-mail, there may only be a few collaborators, thus reducing the number of rows created in a term-document index for a given e-mail.

While clustering based on document contents may provide a very precise resulting set of clusters, as mentioned above, a clustering algorithm run on a large body of text may take a great amount of time to complete.

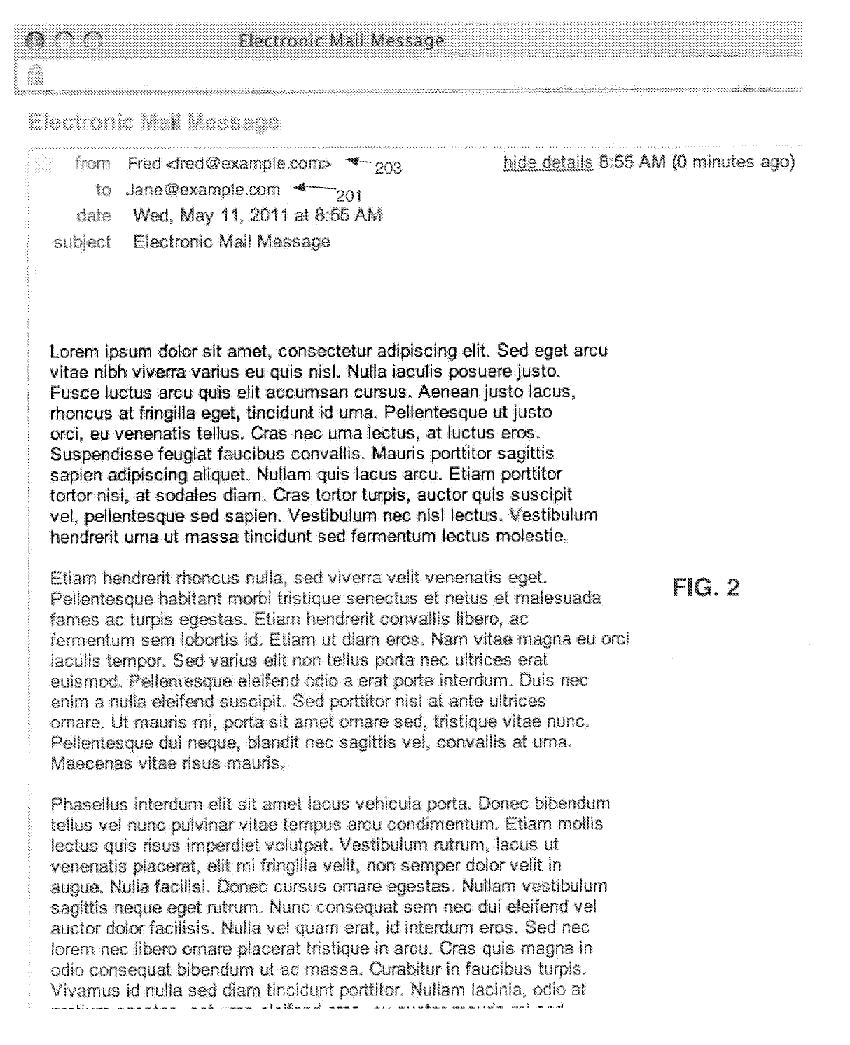

Clustering on non-content parameters of a document, in contrast, takes less time and may still provide very useful end results. FIG. 2 shows exemplary non-content and content portions of an electronic mail message 200. For example, clustering may be performed on data contained in the recipients field 201, represented as one or more addresses in the “to:” line of an e-mail. If the recipients field 201 of a large set of e-mails includes the same recipient or recipients, the set of e-mails may form a cluster. Also, a large set of e-mails may be directed to one recipient, and may be clustered together. Identical recipients over a large set of e-mails may indicate that the e-mails in the set are related to each other, and the recipients and senders of the e-mails in the set may be working on a particular project or topic together.

As mentioned above, other non-content elements of a document may be used for clustering as well. If a set of e-mails contains messages from different user accounts, the e-mails may be clustered first on information contained in the sender field 203. Also, documents may be clustered based on labels or tags associated with the documents, or file names/file paths if the document was placed in a specific folder on the user's computer.

In order to cluster the documents, either agglomerative clustering or partitional clustering may be used. The clustering approach chosen may depend on the advantages and/or disadvantages of each approach, the embodiment chosen, or other criteria requested by a user. However, either clustering approach, or additional clustering approaches known to those skilled in the art, may be used to implement the embodiments described herein.

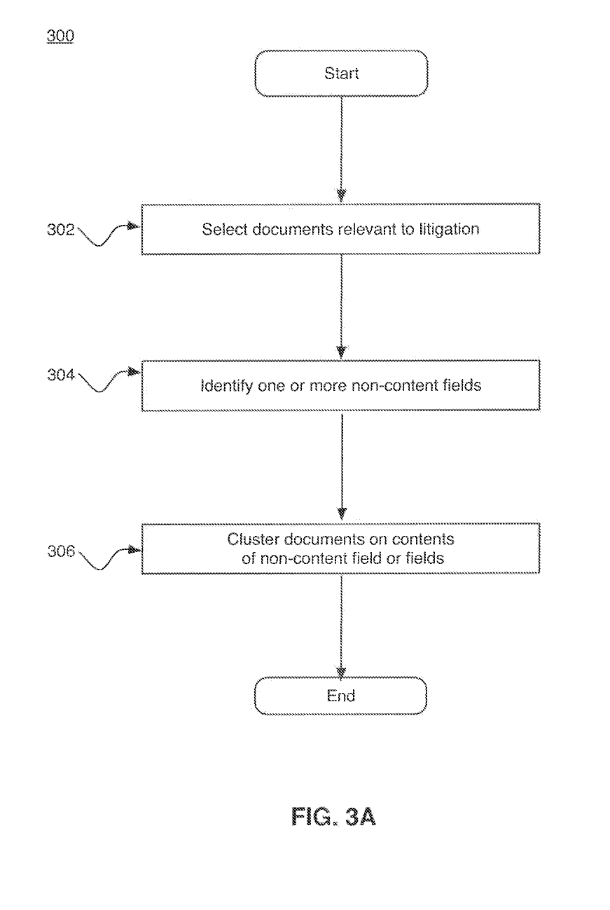

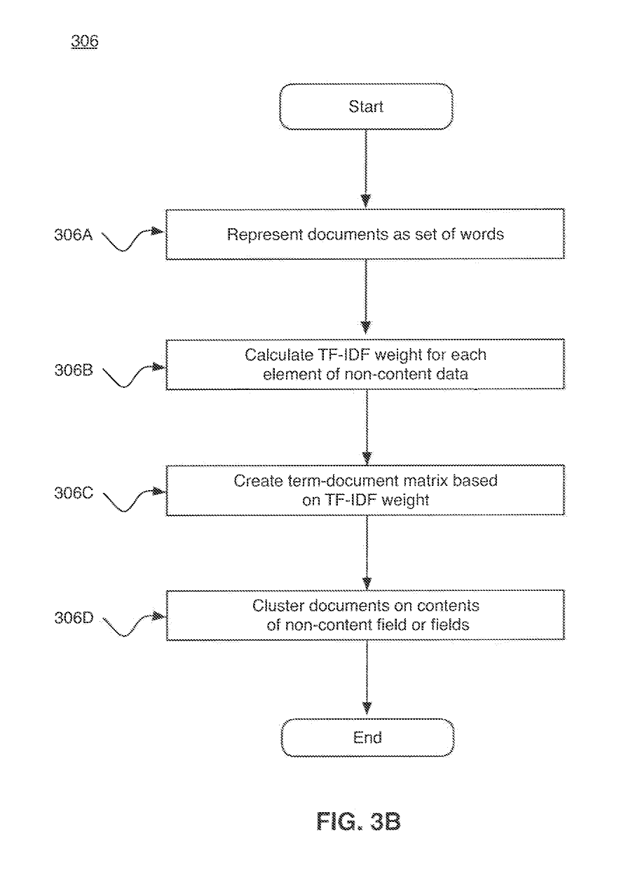

FIG. 3A is an illustration of a method 300 for clustering a set of documents on collaborators or other non-content information.

At block 302, a set of electronic documents to be clustered is selected. The set of electronic documents may be previously determined as being relevant to a litigation. The documents may be e-mails, text documents, spreadsheets, presentations, or any other type of electronic document used.

At block 304, one or more non-content fields associated with each document in the set is identified. For a set of electronic mail messages, for example, a non-content field may be the to: field of an e-mail. For a text document or a spreadsheet, the non-content field may be the creator of a document or a list of the collaborators of a document. Other non-content fields may include, for example and without limitation, a recipient of a document, sender of a document, group recipient of a document, project identifier, the date a document was created, the date a document was modified, or an element of metadata. Additional non-content fields may vary depending on the type of documents to be clustered.

At block 306, the documents in the set established in block 302 are clustered in accordance with the data contained in the non-content field or fields selected in block 304. For example, if the non-content field is the recipients field of an electronic mail message, the resulting clusters may represent sets of documents with common recipients. If the non-content field selected is the collaborators of a spreadsheet, the resulting clusters may represent sets of documents with common collaborators. Further, if more than one non-content field is identified in block 304, such as the recipients field of an electronic mail message and the date the message was sent, the resulting clusters may represent sets of documents with common recipients sent around the same date.

The clustering operation of block 306 may be further described with reference to FIG. 3B. At block 306A of FIG. 3B, each document in the set established at block 302 is represented as a set of words. The set of words model may ignore duplicates of e-mail addresses or other non-content data. Once each document is represented as a set of words, at block 306B, the term frequency-inverse document frequency (TF-IDF) weight may be calculated for each element of non-content data. Thus, for example, if the identified non-content field is the from: field of an e-mail, the TF-IDF weight may be calculated for each address appearing in the from: field of the e-mails in the set.

The TF-IDF weight is a statistical measure of how important a given term is to a document in a set of documents or corpus. The TF-IDF weight increases as the occurrence of the term increases in a document, but decreases as the term occurs more often in the set of documents.

The TF-IDF weight may not be calculated for elements of non-content data that appear below a threshold number of times. For example, a set of documents may have 10,000 e-mail addresses appearing in the from: field. A member of a legal team may only wish to cluster on addresses appearing above 300 times, for example. Thus, the TF-IDF weight may only be calculated on e-mail addresses or other elements of non-content data that appear over a threshold number of times.

Once the TF-IDF weight is calculated for the elements of data in the non-content field, at block 306C, a term-document matrix may be created, based on the TF-IDF weights, to create a representation of the documents to be clustered and the non-content fields and data in each document. Documents may be compared to determine their similarity using cosine similarity, or other known similarity measures.

Based on this information, documents may be clustered at block 306D using any well known clustering algorithm, such as partitional clustering, k-means clustering, hierarchical agglomerative clustering, or any other clustering algorithm suitable for clustering large sets of documents, to create clusters of documents.

In an embodiment, before documents are clustered, data contained in the one or more non-content fields is normalized. Normalizing data may include making data representing the same concept consistent from element to element. For example, a system implementing method 300 explained above may treat an e-mail address formatted as JohnSmith@google.com as different from johnsmith@google.com. However, e-mails sent to either address are received by the intended recipient. Normalizing data may take two e-mail addresses such as the above, and normalize them to a consistent value, such as johnsmith@google.com, so that they only represent one data point. Thus, when clustering based on e-mail addresses, only one cluster will be formed with the e-mails sent to the recipient. In an embodiment, data contained in the non-content fields is not normalized. In some computing environments, formatting or other differences may have a secondary meaning. Thus, in order to preserve this secondary meaning and create clusters that may group these differences together, data may not be normalized prior to clustering.

Once the documents are clustered, the resulting clusters may be used for a number of operations. In an embodiment, clusters may be exported to a document review tool for further analysis. For example, a cluster that identifies a group of e-mail addresses as belonging to a cluster may be reviewed by a member of a legal department familiar with the issues and subjects contained in the cluster. Also, a cluster may be exported or sent to a repository of documents to be later reviewed.

In an embodiment, clusters created as a result of method 300 may be further filtered according to desired criteria. Filter criteria may specify other non-content fields not used by the clustering algorithm. In the above example, a cluster may be filtered based on a particular e-mail address or other criteria to identify documents relevant to a particular matter. For example, one or more clusters may be used in a document review tool by members of a legal department or outside counsel to review documents for a litigation. In an embodiment, filter criteria may be one or more content fields, such as the body or subject of an e-mail, or text contained in a text document.

In an embodiment, in order to simplify the clustering operation and decrease the time necessary to cluster the set of documents, once the non-content field or fields to cluster on are identified, elements of non-content information that only appear infrequently in the set may be filtered out. Thus, for example and without limitation, if the set of documents is to be clustered on recipients of e-mail messages, an e-mail address that only appears twice in a set of 1000 documents as the recipient may be filtered and excluded from clustering. In this way, only documents that contain e-mail addresses that would result in useful clusters are clustered together.

In an embodiment, weights may be assigned to one or more non-content fields to direct the results of a particular clustering algorithm. In an electronic mail message, for example, recipients of the message may be listed in each of the to: field and the cc: field of the message. However, recipients listed in the to: field may be more indicative of the message's similarity to other messages, whereas recipients listed in the cc: field may not be as important. Thus, the addresses contained in the to: field may be assigned a greater weight than addresses in the cc: field. Additionally, group names or addresses listed in the to: field of an e-mail may be indicative of common themes or projects. Thus, group names or addresses may be assigned a greater weight than other addresses.

In an embodiment, one or more clusters of documents created as a result of clustering method 300 may be assigned to a particular reviewer, in accordance with an access control policy. For example, if a cluster of documents is formed with documents created by a high level executive in the organization, a paralegal may not be permitted to view those documents on the basis of confidentiality. Thus, an access control policy may block the paralegal from accessing the contents of the cluster. Similarly, if a cluster of documents involves a group of technical users, the documents may be assigned to a reviewer with similar technical knowledge.

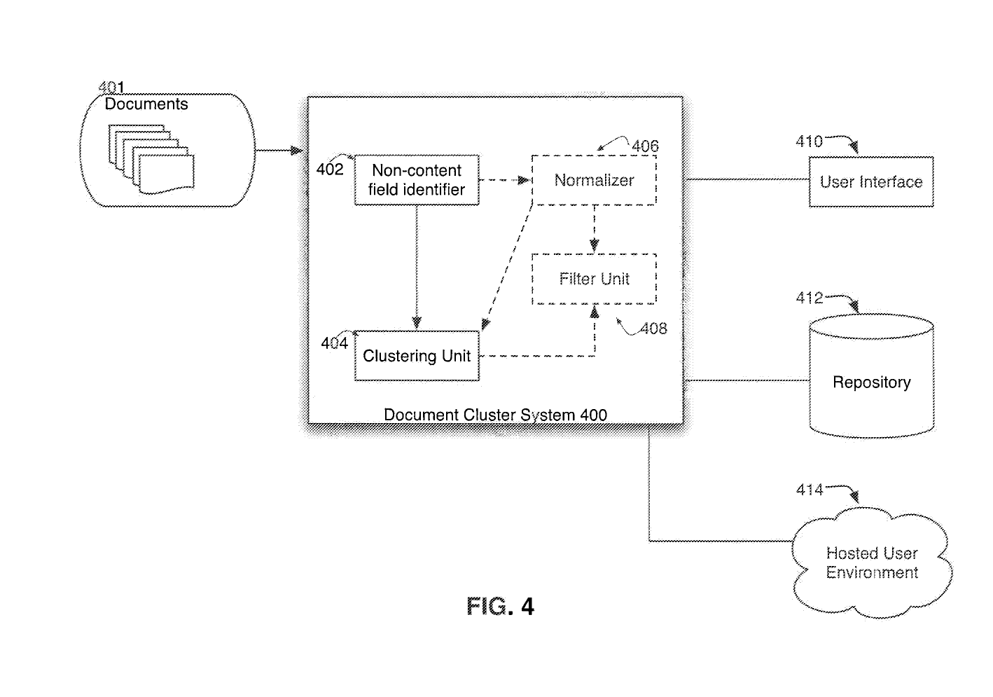

FIG. 4 is an illustration of an exemplary document cluster system 400 used to implement embodiments described herein. For example, document cluster system 400 may execute method 300 identified in FIG. 3 and further explained above, but is not limited and may operate in accordance with other embodiments.

In the embodiment shown in FIG. 4, document cluster system 400 receives documents 401 relevant to a litigation. Documents 401 may be provided from a database or other repository implemented in hardware, software, firmware, or a combination thereof.

Document cluster system 400 contains a non-content field identifier 402. Non-content field identifier 402 may identify or extract non-content fields and data from documents 401, as described with respect to block 302 of method 300.

Document cluster system 400 also contains a clustering unit 404, which utilizes a clustering routine to cluster documents 401 on the basis of data identified by non-content field identifier 402. Clustering unit 404 may be adapted to perform functions such as representing documents as a set of words, calculating TF-IDF weights, creating a term-document incidence matrix and calculating the similarity of two or more documents or clusters. Clustering unit 404 may also be adapted to execute a clustering routine such as an agglomerative, partitional, or another clustering routine, depending on the implementation chosen.

In an embodiment, document cluster system 400 contains a normalizer 406, which normalizes data from non-content field identifier 402 before clustering at clustering unit 404. Data may be normalized as described above with respect to an embodiment.

In an embodiment, document cluster system 400 also contains a filter unit 408. Filter unit 408 may take normalized data from normalizer 406 or data from non-content field identifier 402 and filter data in accordance with an embodiment. For example, filter unit 408 may output documents with non-content data that satisfy particular criteria, such as a threshold number of occurrences.

Filter unit 408 may also take the results of clustering unit 404 to further filter the results of the clustering operation, in accordance with an embodiment. For example, filter unit 408 may filter the results provided from clustering unit 404 on data contained in content fields of documents 401.

Document cluster system 400 may be connected to a user interface 410. User interface 410 may allow a user to specify which non-content fields are extracted or identified by non-content field identifier 402. Additionally, user interface 410 may allow a user to control the operation of normalizer 406 or filter unit 408. Further, user interface 410 may allow a user to specify weights for particular non-content fields to clustering unit 404, in accordance with an embodiment.

Document cluster system 400 may further be connected to a repository 412 to store the results of clustering unit 404. Repository 412 may be used to store documents for a document review system. Document cluster system 400 may also be connected to a hosted user environment 414, as described below.

In an embodiment, documents to be clustered are distributed across a plurality of clients in a hosted user environment. In a hosted user environment utilizing a distributed file system, documents are not stored on a central server or on individual user devices. Instead, documents are distributed over multiple storage machines connected to a network. In this embodiment, a system such as the system described in FIG. 4 may be connected to the network of the hosted user environment to enable clustering and further analysis of documents in a hosted user environment.

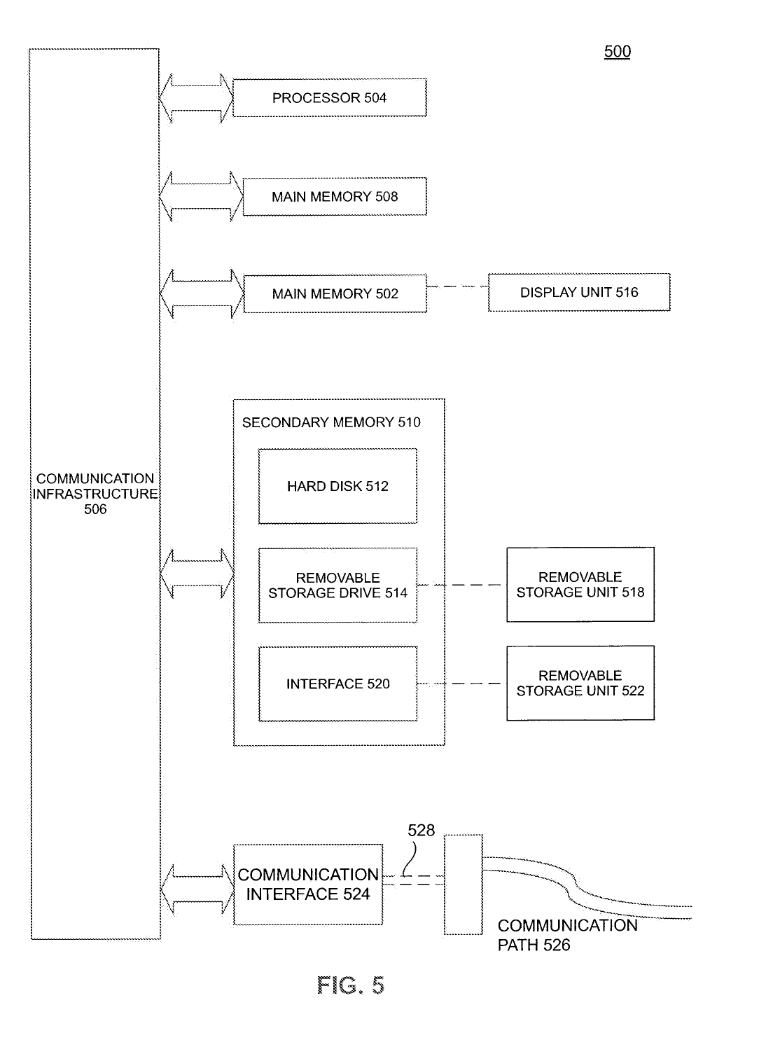

Various aspects of the present invention can be implemented by software, firmware, hardware, or a combination thereof. FIG. 5 illustrates an example computer system 500 in which the embodiments, or portions thereof, can be implemented as computer-readable code. For example, document cluster system 400 carrying out method 300 of FIG. 3 can be implemented in system 500. Various embodiments of the invention are described in terms of this example computer system 500.

Computer system 500 includes one or more processors, such as processor 504. Processor can be a special purpose or a general purpose processor. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive and/or a removable storage drive. Removable storage drive 514 may include a floppy disk drive, a magnetic tape drive, an optical disk drive, a flash memory, or the like. The removable storage drive 514 reads from and/or writes to removable storage unit 518 in a well known manner. Removable storage unit 518 may include a floppy disk, magnetic tape, optical disk, etc. which is read by and written to by removable storage drive 514. As will be appreciated by persons skilled in the relevant art(s), removable storage unit 518 includes a computer readable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and may be implemented using wire or cable, fiber optics, a phone line, a cellular phone link, an RF link or other communications channels.

In this document, the terms “computer program medium” and “computer readable medium” are used to generally refer to media such as removable storage unit 518, removable storage unit 522, a hard disk installed in hard disk drive 512, and signals carried over communication path 526. Computer program medium and computer readable medium can also refer to memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the embodiments as discussed herein. In particular, the computer programs, when executed, enable processor 504 to implement the processes of the present invention, such as the steps in the method illustrated by flowchart 300 of FIG. 3 discussed above. Accordingly, such computer programs represent controllers of the computer system 500. Where embodiments are implemented using software, the software may be stored in a computer program product and loaded into computer system 500 using removable storage drive 514, interface 520, hard drive 512 or communications interface 524.

Embodiments may be implemented in hardware, software, firmware, or a combination thereof. Embodiments may be implemented via a set of programs running in parallel on multiple machines. In an embodiment, different stages of the described methods may be partitioned according to, for example, the number of documents to be clustered, and distributed on the set of available machines.

The summary and abstract sections may set forth one or more but not all exemplary embodiments of the present invention as contemplated by the inventor(s), and thus, are not intended to limit the present invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, only the following claims and their equivalents.

What is claimed is:

1. A method of clustering a set of documents considered to be relevant to a litigation, comprising:
selecting a set of documents determined to be relevant to a litigation from a hosted user environment;
identifying one or more non-content fields associated with each document in the set;
representing each document as a set of words based on the one or more non-content fields;
calculating the term frequency-inverse document frequency weight for each element of data in the identified non-content fields, wherein each element of data in the non-content fields is a term, and wherein the term frequency-inverse document frequency weight is not calculated for elements of data in non-content fields that do not appear a threshold number of times;
creating a term-document incidence matrix based on the term frequency-inverse document frequency weights; and
clustering, by a processor, documents based on the term-document incidence matrix into clusters of documents.

2. The method of claim 1, further comprising normalizing the data contained in the one or more non-content fields.

3. The method of claim 1, wherein the one or more non-content fields includes at least one of a document creator, recipient of a document, sender of a document, group recipient of a document, project identifier, or an element of metadata.

4. The method of claim 1, wherein the step of identifying one or more non-content fields associated with each document in the set further comprises assigning weights to each one or more non-content fields associated with each document in the set.

5. The method of claim 1, further comprising exporting one or more clusters of documents to a repository or a document review tool.

6. The method of claim 1, further comprising assigning one or more clusters of documents to a designated reviewer of documents in accordance with an access control policy.

7. The method of claim 1, wherein the set of documents is distributed across a plurality of clients in a hosted user environment.

8. The method of claim 1, further comprising filtering one or more clusters of documents in accordance with specified filter criteria.

9. The method of claim 8, wherein the filter criteria comprises one or more content fields.

10. The method of claim 1, further comprising specifying a maximum number of documents per cluster.

11. A system for clustering a set of documents considered to be relevant to a litigation, comprising:
a non-content field identifier that identifies non-content fields in the set of documents and data in the non-content fields; and
a clustering unit that clusters documents in the set of documents on data based on data in the non-content fields, wherein the clustering unit is configured to:
represent each document in the set of documents as a set of words based on the one or more non-content fields,
calculate the term frequency-inverse document frequency for each element of data in the non-content fields, wherein each element of data in the non-content fields is a term, and wherein the term frequency-inverse document frequency weight is not calculated for elements of data in the non-content fields that do not appear a threshold number of times,
create a term-document incidence matrix based on the term-frequency-inverse document frequency weights, and
cluster documents based on the term-document incidence matrix into clusters of documents.

12. The system of claim 11, further comprising a normalizer that normalizes data in the non-content fields.

13. The system of claim 11, further comprising a filter unit that filters clusters of documents in accordance with specified filter criteria.

14. A computer readable storage medium containing control logic stored thereon that, when executed by one or more processing devices, causes the one or more processing devices to cluster a set of documents considered to be relevant to a litigation, the control logic comprising:
a first computer readable program code that selects a set of documents determined to be relevant to a litigation from a hosted user environment;
a second computer readable program code that identifies one or more non-content fields associated with each document in the set;
a third computer readable program code that represents each document as a set of words based on the one or more non-content fields;
a fourth computer readable program code that calculates the term frequency-inverse document frequency weight for each element of data in the identified non-content fields, wherein each element of data in the non-content fields is a term, and wherein the term frequency-inverse document frequency weight is not calculated for elements of data in non-content fields that do not appear a threshold number of times;
a fifth computer readable program code that creates a term-document incidence matrix based on the term frequency-inverse document frequency weights; and
a sixth computer readable program code that clusters, by a processor, documents based on the term-document incidence matrix into clusters of documents.

15. The computer readable storage medium of claim 14, further comprising:
a seventh computer readable program code that normalizing the data contained in the one or more non-content fields.

16. The computer readable program code of claim 14, wherein the one or more non-content fields includes at least one of a document creator, recipient of a document, sender of a document, group recipient of a document, project identifier, or an element of metadata.

17. The computer readable program code of claim 14, wherein the second computer readable program code further assigns weights to each one or more non-content fields associated with each document in the set.

18. The computer readable program code of claim 14, further comprising a seventh computer readable program code that exports one or more clusters of documents to a repository or a document review tool.

19. The computer readable program code of claim 14, further comprising a seventh computer readable program code that assigns one or more clusters of documents to a designated reviewer of documents in accordance with an access control policy.

20. The computer readable program code of claim 14, wherein the set of documents is distributed across a plurality of clients in a hosted user environment.

21. The computer readable program code of claim 14, further comprising a seventh computer readable program code that filters one or more clusters of documents in accordance with specified filter criteria.

22. The computer readable program code of claim 15, wherein the filter criteria comprises one or more content fields.

23. The computer readable program code of claim 14, further comprising a seventh computer readable program code that specifies a maximum number of documents per cluster.
